(19) United States
(12) Patent Application Publication
(10) Pub. No.: US 2024/0330871 A1
(43) Pub. Date: Oct. 3, 2024

(54) RECORDAL SYSTEM

(71) Applicant: Emmanuel Mokutu, Soweto (ZA)

(72) Inventor: Emmanuel Mokutu, Soweto (ZA)

(21) Appl. No.: 18/273,883

(22) PCT Filed: Apr. 1, 2021
(86) PCT No.: PCT/IB2021/052722

§ 371 Date: Jul. 24, 2023

(30) Foreign Application Priority Data
Jan. 25, 2021 (ZA) 2021/00491

(51) Int. Cl. G06Q 10/20; G06T 7/00

(52) U.S. Cl. CPC G06Q 10/20; G06T 7/0004; G06T 2207/30248

(57) ABSTRACT

Recordal system (1) for identifying and recording blemishes (4) found on a vehicle (3), comprising a digital camera (2) to scan the vehicle (3) to identify any blemishes (4) and a storage means for storing the locations of the blemishes (4) on the vehicle (3). There is provided for the location of the blemish (4) to be stored in relation to a representation of the vehicle (3) and for the representation to be a graphic representation.

### FIELD OF THE INVENTION

This invention relates to a recordal system, more specifically a recordal system for identifying and recording blemishes found on a vehicle.

### BACKGROUND TO THE INVENTION

Taiwanese patent number TW201926192A in the name of [symbol] entitled “Processing method and device of identifying object damage, server and client” discloses a processing method, device, server, and client for identifying an object damage. Before using the rented object, the user can take a picture, take a picture, etc. through a terminal device such as a mobile phone, and obtain an object damage situation before the user rents the object. When the user returns the rented object, the terminal can be used to shoot again, and the damage of the object at the time of return can be obtained. In this way, the comparison of the damage information before and after the object rental can automatically identify whether the user causes the vehicle damage, and for the user, the user clearly defines the damage situation before the use of the object before the user rents. On the other hand, with the implementation scheme provided in this manual, the staff of the service side can eliminate the identification, confirmation and audit of the vehicle damage on site, which can effectively save labour costs and realize rapid damage identification, responsibility definition, and loss determination. Improve user experience and object damage processing efficiency.

The prior art discloses a method where a user or lessee is required to record any damage to a rental car. The problem is that not all lessees know what to look for and to what extent document any damage relating to a rental car. The recordal involves taking a video or a large amount of images which must be searched to locate damage on a vehicle. This process may be time consuming if the location of the damage is not recorded to save time i.e., to obviate the need to review a lengthy video or a large number of images.

Furthermore, if the lessee is in a hurry to take possession of the vehicle, they may not perform a proper inspection, or not perform an inspection at all.

### OBJECT OF THE INVENTION

It is an object of this invention to provide a recordal system which, at least partially, alleviates some of the above-mentioned difficulties.

### SUMMARY OF THE INVENTION

In accordance with this invention there is provided a recordal system comprising a digital camera to scan a vehicle to identify any blemishes, storage means for storing the location of the blemish on the vehicle.

There is provided for the location of the blemish to be stored in relation to a representation of the vehicle.

A further feature of the invention provides for the representation to be a graphic representation.

A visual image of the blemish is also stored in the storage means.

The date and time of the recordal of the data is stored.

There is provided that the digital camera is the camera of a mobile phone.

A further feature of the invention provides for the digital camera to be mounted to a structure such as a frame through which the vehicle is movable or a movable arm or crane such as a boom carrying the camera which is movable around the vehicle. The invention is not limited to the use of a handheld digital camera.

There is further provided a recording system operating method comprising the steps of scanning a vehicle by means of a digital camera, identifying any blemishes on the vehicle, and recording and storing the location of any blemishes to a storage means.

A further step includes storing the location of any blemishes on a visual representation of a vehicle.

A further step includes mounting the camera to a structure such as a frame through which the vehicle is movable or a movable arm or crane such as a boom carrying the camera which is movable around the vehicle. The invention is not limited to the use of a handheld digital camera.

There is provided for the visual representation of the vehicle to approximate the type or shape of the actual vehicle.

These and other features of the invention are described in more detail below.

### BRIEF DESCRIPTION OF THE DRAWINGS

One embodiment of the invention is described below, by way of example only, with reference to the drawings in which:

FIG. 1 shows implementation of part of a recordal system-used to scan a vehicle for blemishes; and

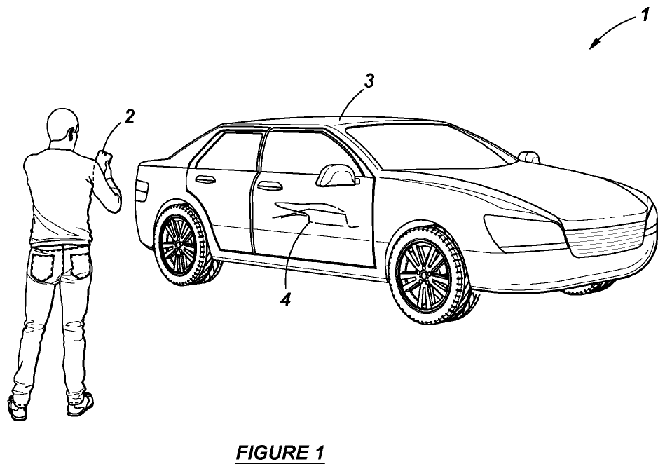

FIG. 2 shows a screen of a mobile device which is used by the recordal system to depict a blemish and other details relating to the blemish.

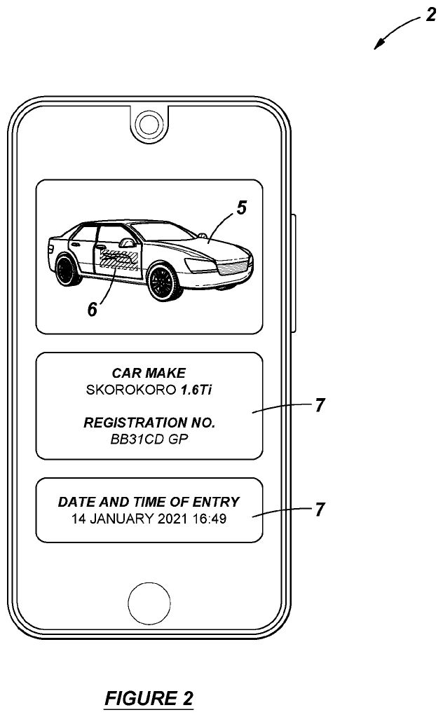

### DETAILED DESCRIPTION OF THE DRAWINGS

With reference to the drawings, a recordal system is generally indicated by reference numeral 1.

The recordal system 1 makes use of a digital camera 2 to scan a vehicle 3 to identify any blemishes 4.

The recordal system 1 makes use of a storage means (not shown) for storing data relating to the location 6 of the blemish 4 on the vehicle 5.

The location 6 of the blemish 4 is stored and indicated on a representation of the vehicle 3.

The representation is a graphic representation 5. This may be a general shape of the vehicle or a three-dimensional rendering of the shape of vehicle. For example, if the actual vehicle is a truck, the graphic representation will be that of a truck. Likewise, if the actual vehicle is a sedan, the graphic representation will be that of a sedan. Graphic representation of trucks, sedans, hatchbacks and the like will be stored in a database.

In order to save on computing power, storage space and bandwidth, only data relating to the location 6 and timestamps of the blemish 4 is stored which can easily be superimposed on the graphical representation of a generic vehicle shape.

The date and time when the of the recordal is recorded in order to have certainty of the moment at which the blemish 4 is first identified.

The digital camera 2 is part of a mobile device, such as a cellular phone, tablet computer or small portable computer.

The camera 2 can take photographs, videos or a three-dimensional scan of the vehicle.

Blemishes 4 in the form of scratches, dents, chips or cracks found on the bodywork, windows or accessories of the vehicle 3 will be identified, recorded and compared to existing data relating to the vehicle 3.

Blemishes 4 which are found in the scan process are compared to old data relating to the vehicle 3 and if the blemish 4 is new the blemish 4 is recorded and timestamped.

The system 1 documents the location 6 of the blemish on a generic representation 5 of the vehicle shape, rather than an actual photograph of the vehicle 3 being scanned.

The data captured can be represented at a later stage on the screen of the mobile device or on a second device.

In use, a user will use the digital camera 2 on a mobile device to scan a vehicle 4 by walking around the vehicle 3 whilst software incorporating the recording system 1 on the mobile device captures data recorded by the digital camera 2. The software identifies any blemishes 4 found on the vehicle 3 and compare data relating to the location 6 of the blemish 4, to existing data relating to the vehicle 3. If is the blemish is new i.e., there is no data relating to a similar blemish 4 at the same location 6, the software will record the location 6 of the blemish 4 together with a time and date stamp 7. The location 6 of the blemish 4 is retrievable at a later point in time when the software merely highlights the location 6 of the blemish 4 on a graphical representation off a similar shaped vehicle 5.

In another embodiment, a photograph of the blemish 4 is also stored in the storage means. When the graphical representation of a vehicle 5 is retrieved, the user can select the location 6 of a blemish 4 and an actual photograph of part of the vehicle 3 is be shown.

It is in envisaged that the recording system will become part of vehicle rental agencies' day-to-day procedures. It will alleviate many disputes regarding if the vehicle was damaged while in possession of the person who rented it. Both parties, the rental agency, and the lessee, will have access to the graphical representation of the motor vehicle before and after the rental period. The invention will also be applicable for use by vehicle service centers and the like.

It will be appreciated by those skilled in the art that the invention is not limited to the precise details as described herein. For example, the software will allow a photograph or details of a blemish to be manually inserted if it is not identified by the software. In this case, the user and the owner of the vehicle will have the opportunity to authorise such recordal.

1. A recordal system comprising a digital camera to scan a vehicle to identify any blemishes, storage means for storing the location of the blemish on the vehicle.

2. The recordal system as claimed in claim 1 wherein the location of the blemish is stored in relation to a representation of the vehicle.

3. The recordal system as claimed in claim 1 wherein the representation of the vehicle is a graphic representation.

4. The recordal system as claimed in in claim 1 wherein a visual image of the blemish is stored in the storage means.

5. The recordal system as claimed in claim 1 wherein the date and time of the recordal of the data is stored.

6. The recordal system as claimed in claim 1 wherein the digital camera is the camera of a mobile phone.

7. The recordal system as claimed in claim 1 wherein the digital camera is mounted to a structure.

8. The recordal system as claimed in claim 1 wherein the structure is movable past the vehicle.

9. The recordal system as claimed in claim 1 wherein the vehicle is movable past the structure.

10. The recordal system as claimed in claim 1 wherein the structure is a movable arm carrying the camera.

11. The recordal system as claimed in claim 1 wherein the storage means is a cloud-based storage.

12. A recording system operating method comprising the steps of:
scanning a vehicle by means of a digital camera;
identifying any blemishes on the vehicle;
recording and storing the location of any blemishes to a storage means.

13. The recording system operating method as claimed in claim 12 further including the step of storing the location of any blemishes on a visual representation of a vehicle.

14. The recording system operating method as claimed in claim 12 further including the step of visually representing the vehicle to approximate the type or shape of the actual vehicle.

15. The recording system operating method as claimed in claim 12 including the steps of mounting the digital camera to a structure.

16. The recording system operating method as claimed in claim 12 including the steps moving the structure past the vehicle.

17. The recording system operating method as claimed in claim 12 including the steps moving the vehicle past the structure.
